(19) United States
(12) Patent Application Publication
(10) Pub. No.: US 2026/0135246 A1
(43) Pub. Date: May 14, 2026

(54) POWER STORAGE DEVICE

(71) Applicant: TOYOTA JIDOSHA KABUSHIKI KAISHA, Toyota-shi (JP)

(72) Inventors: Makoto IWATA, Toyota-shi (JP); Shotaro ISHIKAWA, Miyoshi-shi (JP); Shunsuke Fujiwara, Toyota-shi (JP); Soichiro NAKAMURA, Toyota-shi (JP); Takahiko NAKANO, Toyota-shi (JP); Kosuke SUZUKI, Toyota-shi (JP); Masahiro ISHIZUKA, Toyota-shi (JP); Kensuke MATSUO, Seto-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 19/368,277

(22) Filed: Oct. 24, 2025

(30) Foreign Application Priority Data
Nov. 13, 2024 (JP) 2024-198012

(51) Int. Cl. H01M 50/367; H01M 50/342

(52) U.S. Cl. CPC H01M 50/367; H01M 50/3425; H01M 2220/20

(57) ABSTRACT

A power storage device includes a plurality of power storage cells, a bottom wall, and a panel member that defines an exhaust path along with the bottom wall. Each of the power storage cells includes a cell case that houses an electrode assembly, and a safety valve that is provided on a lower face of the cell case. The bottom wall has a through hole that is provided at a position facing the safety valve. A length of an upper end portion of the through hole in a second direction is greater than a length of the safety valve in the second direction.

### CROSS-REFERENCE TO RELATED APPLICATION

This application claims priority to Japanese Patent Application No. 2024-198012 filed on Nov. 13, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2023-126584 (JP 2023-126584 A), for example, discloses a battery including a plurality of cells, a case that houses the cells, a protective member that protects a bottom portion of the case, and a cover. Each of the cells includes a box that houses an electrode assembly. A relief mechanism is provided on a bottom face of the box, and an external terminal is provided on an upper face of the box. Waste that is discharged from the relief mechanism flows into a collection cavity that is formed between the bottom portion of the case and the protective member.

### SUMMARY

In the battery that is described in JP 2023-126584 A, there is concern that when waste is discharged from the relief mechanism of the cell, some of the waste become diffused into the case without flowing into the collection cavity.

An object of the present disclosure is to provide a power storage device in which waste that is discharged from a power storage cell can be suppressed from being diffused between a cell case and a bottom wall.

A power storage device according to an aspect of the present disclosure includes a plurality of power storage cells that is arrayed along a first direction, a bottom wall that is disposed downward from the power storage cells, and a panel member that is provided downward from the bottom wall and that defines an exhaust path along with the bottom wall, in which each of the power storage cells includes a cell case that houses an electrode assembly, and a safety valve that is provided on a lower face of the cell case, the bottom wall has a through hole that is provided at a position facing the safety valve, and a length of an upper end portion of the through hole in a second direction, perpendicular to both the first direction and an up-down direction, is greater than a length of the safety valve in the second direction.

According to the present disclosure, a power storage device that is capable of suppressing diffusion of waste that is discharged from a power storage cell between a cell case and a bottom wall can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a power storage device according to an embodiment of the present disclosure;

FIG. 2 is a plan view schematically illustrating the power storage device in a state in which an upper cover is removed therefrom;

FIG. 3 is a cross-sectional view taken along line III-III in FIG. 2; and

FIG. 4 is a cross-sectional view taken along line IV-IV in FIG. 2.

### DETAILED DESCRIPTION OF EMBODIMENTS

An embodiment of the present disclosure will be described with reference to the drawings. Note that in the drawings referred to below, members that are the same or are equivalent to being the same are denoted by the same numbers.

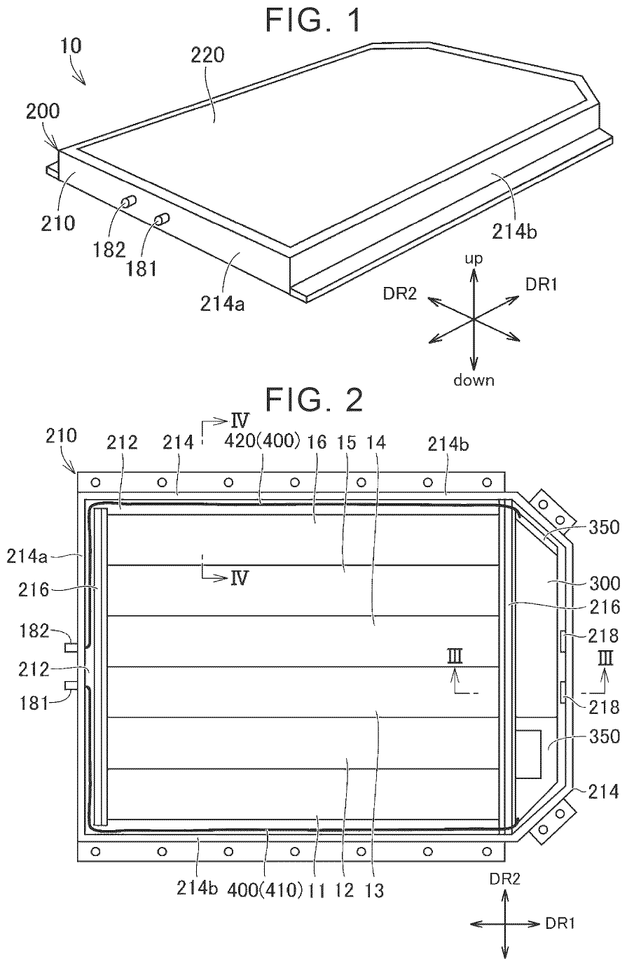

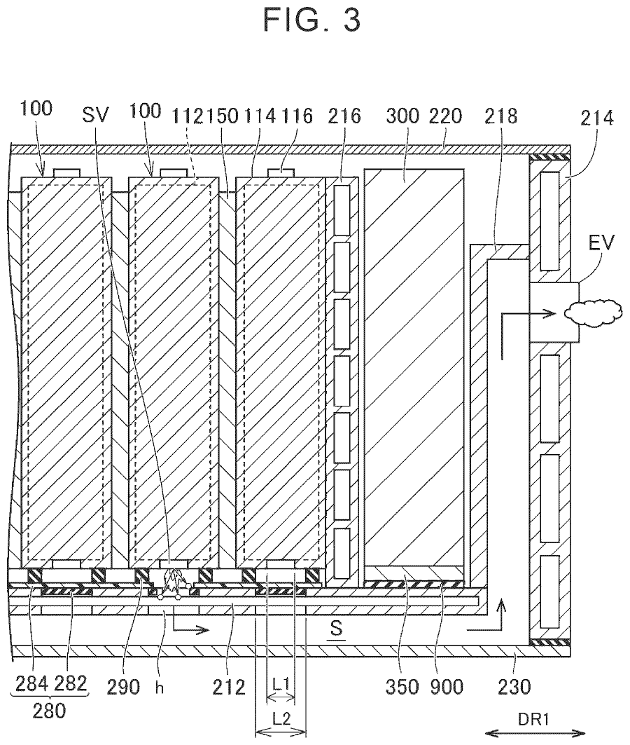

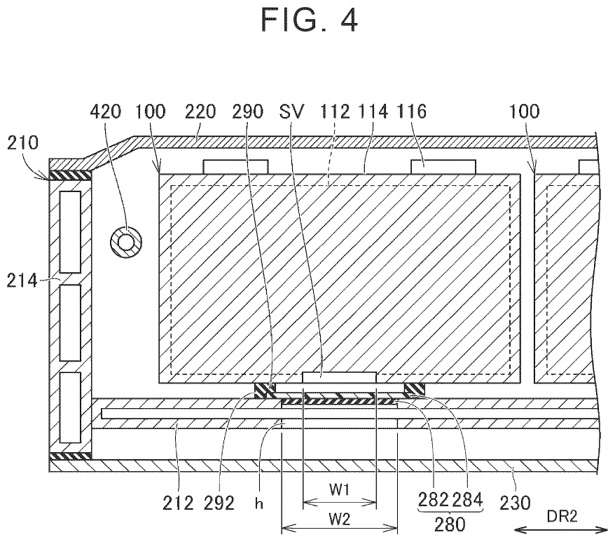

FIG. 1 is a perspective view schematically illustrating a power storage device according to an embodiment of the present disclosure. FIG. 2 is a plan view schematically illustrating the power storage device with an upper cover removed therefrom. FIG. 3 is a cross-sectional view taken along line III-III in FIG. 2. FIG. 4 is a cross-sectional view taken along line IV-IV in FIG. 2.

A power storage device 10 according to the present embodiment is installed at a lower part of a vehicle, for example. Examples of the vehicle include a hybrid electric vehicle, a plug-in hybrid electric vehicle, and a battery electric vehicle.

As illustrated in FIGS. 1 to 4, the power storage device 10 includes six power storage stacks 11 to 16, a housing 200, protective members 280, enclosing members 290, equipment 300, an equipment cooler 350, and a refrigerant pipe 400. Note that the number of the power storage stacks is not limited to six.

Each of the power storage stacks 11 to 16 is formed in a shape of a cuboid that is elongated in a first direction DR1. As illustrated in FIG. 2, the six power storage stacks 11 to 16 are disposed so as to be arrayed along a second direction DR2 that is perpendicular to both the first direction DR1 and an up-down direction. In the present embodiment, the first direction DR1 corresponds to a front-rear direction of the vehicle, and the second direction DR2 corresponds to a right-left direction (width direction) of the vehicle. Each of the power storage stacks 11 to 16 includes at least one power storage cell 100. In the present embodiment, each of the power storage stacks 11 to 16 includes a plurality of the power storage cells 100 and a plurality of cooling plates 150.

The power storage cells 100 are disposed so as to be arrayed along the first direction DR1. As illustrated in FIG. 3, each power storage cell 100 includes an electrode assembly 112, a cell case 114, and a pair of external terminals 116.

The electrode assemblies 112 may each be made up of a wound electrode assembly in which a cathode sheet and an anode sheet are wound with a separator interposed therebetween, or may each be made up of a laminate in which a cathode sheet and an anode sheet are laminated with a separator interposed therebetween. The electrode assemblies 112 is formed in a shape that is elongated in the second direction DR2.

Each of the cell cases 114 houses a respective one of the electrode assemblies 112. The cell case 114 is formed in a cuboid shape. The cell case 114 is made of a metal such as aluminum or the like. A safety valve SV is provided in a lower face of the cell case 114.

The external terminals 116 are provided on an upper face of the cell case 114. The external terminals 116 are provided at positions that are spaced apart from each other in the width direction of the cell case 114. Note that the width direction of the cell case 114 corresponds to the second direction DR2.

As illustrated in FIG. 3, each of the cooling plates 150 is disposed between a pair of the power storage cells 100 adjacent to each other in the first direction DR1. Each of the cooling plates 150 is formed in a shape of a flat plate that is elongated in the second direction DR2. Each of the cooling plates 150 has a flow path (omitted from illustration) through which a refrigerant flows along the second direction DR2.

The housing 200 houses the six power storage stacks 11 to 16. As illustrated in FIGS. 1 to 4, the housing 200 includes a lower case 210, an upper cover 220, and a panel member 230.

The lower case 210 is open upward. The lower case 210 may be made of a metal such as aluminum or the like. The lower case 210 includes a bottom wall 212, a peripheral wall 214, and a pair of partition walls 216.

The bottom wall 212 is located downward from the power storage stacks 11 to 16. In the present embodiment, the bottom wall 212 is formed to be hollow. The bottom wall 212 may be formed by extrusion molding. Note, however, that the bottom wall 212 may be formed as a solid and flat plate. As illustrated in FIGS. 3 and 4, a plurality of through holes h is opened in the bottom wall 212. Each of the through holes h is provided at a position facing a corresponding safety valve SV.

As illustrated in FIG. 3, a length L2 of an upper end portion of the through hole h in the first direction DR1 is greater than a length L1 of the safety valve SV in the first direction DR1. As illustrated in FIG. 4, a length W2 of the upper end portion of the through hole h in the second direction DR2 is greater than a length W1 of the safety valve SV in the second direction DR2.

Note that in the present embodiment, the length L2 of the upper end portion of the through hole h in the first direction DR1 is the same as a length of a lower end portion of the through hole h in the first direction DR1. In the same way, the length W2 of the upper end portion of the through hole h in the second direction DR2 is the same as a length of the lower end portion of the through hole h in the second direction DR2. Note, however, that the length of the through hole h in the first direction DR1 may gradually increase or decrease the further downward. In the same way, the length of the through hole h in the second direction DR2 may gradually increase or decrease the further downward.

The protective members 280 are provided on the bottom wall 212. As illustrated in FIGS. 3 and 4, the protective members 280 include a plurality of thermal insulation members 282 and holding sheets 284.

Each of the thermal insulation members 282 is provided within a corresponding through hole h. Each of the thermal insulation members 282 is shaped so as to close off a corresponding through hole h. In the present embodiment, an upper face of each of the thermal insulation members 282 is set to be flush with an upper face of the bottom wall 212. The thermal insulation members 282 each have a function of protecting the power storage cells 100 from gas that is discharged from the safety valves SV. The thermal insulation members 282 are made of, for example, mica that is solidified by thermally pressing a natural inorganic mineral.

The holding sheets 284 hold the thermal insulation members 282. The thermal insulation members 282 may each be adhered to a rear face of the holding sheets 284. The holding sheets 284 are made of, for example, polypropylene.

The enclosing members 290 are disposed between the lower face of the cell case 114 and the bottom wall 212. The enclosing members 290 are shaped so as to surround respective through holes h. As illustrated in FIGS. 3 and 4, at least a portion of each of the enclosing members 290 comes into contact with a bottom face of the cell case 114, and with the holding sheet 284. A lower face of an end portion 292 of the enclosing member 290 in the second direction DR2 is in contact with the bottom wall 212. An upper face of the enclosing member 290 is in contact with the bottom face of the cell case 114 over the entire region thereof. The enclosing member 290 is made of resin, metal, or the like. Note that a portion of the upper face of the enclosing member 290 may be in contact with a lower face of the cooling plate 150.

The peripheral wall 214 is erected from a peripheral portion of the bottom wall 212. The peripheral wall 214 is shaped to enclose the power storage stacks 11 to 16. The peripheral wall 214 may be formed so as to be hollow. The peripheral wall 214 includes a front wall 214a and a pair of side walls 214b.

The front wall 214a is formed on one side (left side in FIG. 2) of the power storage stacks 11 to 16 in the first direction DR1. The front wall 214a extends in the second direction DR2. Note that in the present embodiment, the one side in the first direction DR1 corresponds to a front side in the front-rear direction of the vehicle.

The side walls 214b face each other across a distance in the second direction DR2. The side walls 214b extend in the first direction DR1. An end portion (front end portion) of each side wall 214b on the one side in the first direction DR1 is connected to the front wall 214a.

The partition walls 216 divide a space surrounded by the bottom wall 212 and the peripheral wall 214 into a space in which the power storage stacks 11 to 16 are disposed, and other spaces. The partition walls 216 are disposed spaced apart from each other in the first direction DR1. The partition walls 216 extend in the second direction DR2. The partition walls 216 may be formed so as to be hollow. The partition walls 216 serve to restrain the power storage stacks 11 to 16 from both sides in the first direction DR1. As illustrated in FIG. 2, each of end portions in the second direction DR2, of the partition wall 216 that is formed on the one side (front side) in the first direction DR1, is spaced apart from a corresponding side wall 214b. Each of the end portions in the second direction DR2, of the partition wall 216 that is formed on the other side (rear side) in the first direction DR1, is connected to a corresponding side wall 214b.

The upper cover 220 is disposed upward from the power storage stacks 11 to 16. The upper cover 220, together with the lower case 210, houses the six power storage stacks 11 to 16. Specifically, the upper cover 220, together with the lower case 210, houses the six power storage stacks 11 to 16 in a sealed state. A peripheral portion of the upper cover 220 is connected to an upper end portion of the peripheral wall 214, with a sealing member interposed therebetween, by bolts or the like.

The panel member 230 is provided downward from the lower case 210. The panel member 230 has a function of protecting the bottom wall 212 of the lower case 210. The panel member 230 may be formed in a shape of a flat plate. A peripheral portion of the panel member 230 is connected to a lower face of the lower case 210, with a sealing member interposed therebetween.

As illustrated in FIG. 3, a space S is formed between the panel member 230 and the bottom wall 212. The space S serves as an exhaust path (hereinafter referred to as “exhaust path S”). The exhaust path S is a path for discharging gas that is discharged from the safety valves SV of the power storage cells 100 to outside of the housing 200.

As illustrated in FIGS. 2 and 3, an exhaust duct 218 is formed in the peripheral wall 214. The exhaust duct 218 extends upward from the bottom wall 212. The exhaust duct 218 guides the gas upward from the exhaust path S. A relief valve EV is provided at an end portion on a downstream side of the exhaust duct 218. The relief valve EV releases pressure within the housing 200. The relief valve EV opens when the pressure within the housing 200 becomes equal to or greater than a reference value. The relief valve EV is made up of a check valve. As illustrated in FIG. 3, when gas is discharged from any of the power storage cells 100, the gas spreads in the first direction DR1 through the exhaust path S and is discharged to the outside of the housing 200 through the exhaust duct 218 and the relief valve EV.

The equipment 300 is housed in the housing 200. As illustrated in FIG. 2, the equipment 300 is disposed on the other side of the lower case 210 in the first direction DR1, that is, in a space that is formed between the partition wall 216 that is formed on the other side (rear side) in the first direction DR1 and the peripheral wall 214. The equipment 300 may include a junction box. The equipment 300 may include a relay, control equipment, and so forth.

The equipment cooler 350 cools the equipment 300. As illustrated in FIGS. 2 and 3, the equipment cooler 350 is provided between the bottom wall 212 and the equipment 300. A thermally conductive adhesive 900 may be provided between the equipment cooler 350 and the bottom wall 212.

The refrigerant pipe 400 is routed within the housing 200. The refrigerant pipe 400 is connected to the cooling plates 150 and the equipment cooler 350. As illustrated in FIGS. 1 and 2, the front wall 214a of the peripheral wall 214 is provided with an inlet port 181 and an outlet port 182. The refrigerant pipe 400 is connected to the inlet port 181 and the outlet port 182. Accordingly, the refrigerant (water, oil, or the like) that is supplied from the inlet port 181 flows into the cooling plates 150 and the equipment cooler 350 through the refrigerant pipe 400, cools the power storage cells 100 and the equipment 300, and then flows out from the outlet port 182 through the refrigerant pipe 400.

As illustrated in FIG. 2, the refrigerant pipe 400 includes an upstream pipe 410 and a downstream pipe 420.

An end portion of the upstream pipe 410 on an upstream side is connected to the inlet port 181. An end portion of the upstream pipe 410 on a downstream side is connected to one end of the equipment cooler 350 in the second direction DR2. The upstream pipe 410 is routed so as to pass between the front wall 214a and the partition wall 216 that is formed on the one side in the first direction DR1, and between the power storage stack 11 that is disposed on one side in the second direction DR2 and the side wall 214b. The upstream pipe 410 is connected to one end portion of each of the cooling plates 150 in the second direction DR2.

An end portion of the downstream pipe 420 on an upstream side is connected to the other end of the equipment cooler 350 in the second direction DR2. An end portion of the downstream pipe 420 on a downstream side is connected to the outlet port 182. The downstream pipe 420 is routed so as to pass between the front wall 214a and the partition wall 216 that is formed on the one side in the first direction DR1, and between the power storage stack 16 that is disposed on the other side in the second direction DR2 and the side wall 214b. The downstream pipe 420 is connected to the other end portion of each of the cooling plates 150 in the second direction DR2.

In the power storage device 10 described above, when waste is discharged downward from the safety valve SV because of short-circuiting or the like in any of the power storage cells 100, the waste collides against the holding sheet 284 and the thermal insulation member 282. As a result, the holding sheet 284 melts and also the thermal insulation member 282 splits.

In the present embodiment, the length L2 of the upper end portion of the through hole h in the first direction DR1 is greater than the length L1 of the safety valve SV in the first direction DR1, and the length W2 of the upper end portion of the through hole h in the second direction DR2 is greater than the length W1 of the safety valve SV in the second direction DR2, and accordingly the waste that is discharged from the safety valve SV effectively flows into the exhaust path S through the through hole h. This suppresses the waste containing contents of the power storage cell 100 (so-called debris) from being diffused between the cell case 114 and the bottom wall 212.

Thereafter, gas that is contained in the waste spreads through the exhaust path S and is discharged from the housing 200 through the relief valve EV, as illustrated in FIG. 3. Thus, adhesion of the content of the power storage cell 100 to the external terminals 116 and so forth is suppressed.

It will be understood by a person skilled in the art that the exemplary embodiment described above is a specific example of the following aspects.

### Aspect 1

A power storage device including a plurality of power storage cells that is arrayed along a first direction, a bottom wall that is disposed downward from the power storage cells, and a panel member that is provided downward from the bottom wall and that defines an exhaust path along with the bottom wall, in which each of the power storage cells includes a cell case that houses an electrode assembly, and a safety valve that is provided on a lower face of the cell case, the bottom wall has a through hole that is provided at a position facing the safety valve, and a length of an upper end portion of the through hole in a second direction, perpendicular to both the first direction and an up-down direction, is greater than a length of the safety valve in the second direction.

In this power storage device, the length of the upper end portion of the through hole in the second direction is greater than the length of the safety valve in the second direction, and accordingly waste discharged from the safety valve effectively flows into the exhaust path through the through hole. Thus, diffusion of the waste between the cell case and the bottom wall is suppressed.

### Aspect 2

The power storage device according to Aspect 1, in which a length of the upper end portion of the through hole in the first direction is greater than a length of the safety valve in the first direction.

In this Aspect, diffusion of the waste between the cell case and the bottom wall is more reliably suppressed.

### Aspect 3

The power storage device according to Aspect 1 or 2, further including an enclosing member that is provided between the cell case and the bottom wall, and that is of a shape enclosing the through hole.

In this Aspect, the enclosing member blocks diffusion of the waste, and accordingly diffusion of the waste between the cell case and the bottom wall is more reliably suppressed.

### Aspect 4

The power storage device according to Aspect 3, further including a protective member that is provided on the bottom wall, in which the protective member includes a plurality of thermal insulation members each closing off a respective one of the through holes, and a holding sheet that holds the thermal insulation members, and at least a portion of the enclosing member is in contact with a bottom face of the cell case and the holding sheet.

Note that the embodiment disclosed herein should be considered to be exemplary in all respects and not restrictive. The scope of the present disclosure is set forth in the claims, and not the description of the embodiment described above, and further all changes within the meaning and scope equivalent to the claims are included therein.

What is claimed is:

1. A power storage device, comprising:
a plurality of power storage cells that is arrayed along a first direction;
a bottom wall that is disposed downward from the power storage cells; and
a panel member that is provided downward from the bottom wall and that defines an exhaust path along with the bottom wall, wherein
each of the power storage cells includes
a cell case that houses an electrode assembly, and
a safety valve that is provided on a lower face of the cell case,
the bottom wall has a through hole that is provided at a position facing the safety valve, and
a length of an upper end portion of the through hole in a second direction, perpendicular to both the first direction and an up-down direction, is greater than a length of the safety valve in the second direction.

2. The power storage device according to claim 1, wherein a length of the upper end portion of the through hole in the first direction is greater than a length of the safety valve in the first direction.

3. The power storage device according to claim 1, further comprising an enclosing member that is provided between the cell case and the bottom wall, and that is of a shape enclosing the through hole.

4. The power storage device according to claim 3, further comprising a protective member that is provided on the bottom wall, wherein
the protective member includes
a plurality of thermal insulation members each closing off a respective one of the through holes, and
a holding sheet that holds the thermal insulation members, and
at least part of the enclosing member is in contact with a bottom face of the cell case and the holding sheet.
